(19) United States
(12) Patent Application Publication
(10) Pub. No.: US 2021/0200784 A1
(43) Pub. Date: Jul. 1, 2021

(54) Regionalized lawn maintenance management system and method

(71) Applicant: Hao Zhou, Shanghai (CN)

(72) Inventor: Hao Zhou, Shanghai (CN)

(21) Appl. No.: 16/878,438

(22) Filed: May 19, 2020

(30) Foreign Application Priority Data
Dec. 31, 2019 (CN) 201911421193.7

(51) Int. Cl. G06F 16/26; G06F 16/22; G06F 16/2457; A01D 42/00; G01W 1/10

(52) U.S. Cl. CPC G06F 16/26; G06F 16/2228; A01D 2101/00; A01D 42/00; G01W 1/10; G06F 16/24573

(57) ABSTRACT

The invention relates to a regional lawn maintenance management system and method, and relates to the technical field of lawn maintenance management, mainly including lawn maintenance terminal equipment, evaluation equipment, intelligent computing equipment, community terminal equipment, data visualization equipment, connected through a communication network, the management equipment, database and commercial operation equipment can fully evaluate the users condition before the user conducts regional lawn maintenance management. The intelligent computing equipment and evaluation equipment generate suitable data based on the evaluation data information and/or historical evaluation data information before, and after the maintenance of the lawn based on the users maintenance plan information and feedback from the lawn maintenance terminal equipment, the maintenance plan information is continuously optimized in subsequent maintenance or data processing to generate a set of targeted maintenance plans, and the comparison is obtained at the regional level. The macro regional turfgrass data provides the function of regional turfgrass maintenance and decision-making, so that turfgrass management can be regionalized, refined, intensive and intelligent.

### CROSS REFERENCE TO RELATED APPLICATIONS

This patent application claims the benefit of a Chinese Patent application Number; 201911421193.7, filed Dec. 31, 2019, Both of the above applications are incorporated by reference herein.

### TECHNICAL FIELD

The invention relates to the technical field of lawn maintenance management, in particular to a regional lawn maintenance management system and method.

### BACKGROUND

With the advancement of urbanization, improving the health service value of urban green space resources through the optimized management of urban green space resources is very important for improving the urban living environment, improving the happiness, physical, and mental health of urban residents, and at the same time improving the utilization of urban green space resources are an important supplement.

Lawn is an important part of public green space, and its maintenance and data collection and processing are an important part of turf management regionalization. However, at present, it is relatively common to use a single device to perform lawn maintenance. For example, the utility model patent with the publication number CN203226033U discloses an intelligent lawn maintenance robot, which includes a flip cover, a housing, a metal point and an infrared sensing device arranged in front of the housing, the housing and the chassis. A chassis cover is installed between the chassis. A walking wheel drive motor, a walking wheel, a mowing motor, and a cutter head lifting device are installed on the chassis. The walking motor drives the walking wheel to rotate. A collision signal processing device is also installed on the chassis. The processing device and the tilt switch device, the collision signal processing device include a push plate, a micro switch and a circuit control board located on the front side of the chassis. An infrared sensor device is provided on the lower side of the rear of the chassis. If it is lifted in the running state, the cutter head will immediately stop running to ensure personal safety; a collision signal processing device that automatically avoids obstacles is provided. When encountering obstacles, an external force is applied to the front end of the housing, and the push plate is indirectly pushed by the plastic elastic deformation. After the push plate moves to a certain distance, the micro switch is pressed. After the circuit control board receives the signal, the walking motor is instructed to avoid obstacles. After the external force of the collision disappears. The push plate is restored to its original position under the action of the elastic component, and the front end of the housing recovers by itself.

### SUMMARY

In view of the shortcomings of the existing technology, the first objective of the present invention is to provide a regional lawn maintenance management system, so that lawn management can be regionalized, refined, intensive and intelligent.

The above-mentioned first objective of the present invention is achieved by the following technical solutions.

A regionalized lawn maintenance management system is characterized by including lawn maintenance terminal equipment, evaluation equipment, intelligent computing equipment, community terminal equipment, management terminal equipment, and database connected via a communication network, wherein the lawn maintenance terminal equipment is used to collect user's lawn maintenance-related data and automatically intelligently trim and maintain the lawn. The user lawn maintenance-related data is transmitted and exchanged to each device through the communication network, and the maintenance plan information is converted into specific lawn maintenance operations according to the set algorithm action.

The community terminal equipment is used by the community administrator to collect and input user change data before and after user initialization and maintenance, and exchange data with other equipment such as lawn maintenance terminal equipment through the communication network.

The evaluation equipment exchanges data with other equipment through the communication network. After the database-based knowledge base and the data of the lawn maintenance terminal equipment are input into the intelligent computing equipment for calculation, the evaluation is made based on its own algorithm program, and the evaluation data is transmitted to the management equipment by the management personnel. Judgment and confirmation, relevant data are transmitted to the lawn maintenance terminal and database through the communication network.

The intelligent computing device receives information from the lawn maintenance terminal equipment and other equipment, generates maintenance plan information based on the built-in setting algorithm program, and outputs it to the lawn maintenance terminal equipment and other equipment after confirmation by the management terminal equipment.

The management terminal device receives the lawn attribute and maintenance plan information output from the evaluation device and the database, determines and confirms the feasibility of the included maintenance plan according to the operation of the manager, and if feasible, outputs the maintenance plan information to the lawn maintenance terminal device.

The database receives and stores various data information and various setting algorithm data output by each device, forming historical data, multiple intelligent calculation data and knowledge base.

By adopting the above technical solutions, the user can fully evaluate his own condition before performing regional lawn maintenance management, and then the intelligent computing device and the evaluation device generate suitable data for the above based on the evaluation data information and/or historical evaluation data information before, and after the lawn maintenance. The user's maintenance plan information, and according to the feedback of the lawn maintenance terminal equipment, the above maintenance plan information is continuously optimized in subsequent maintenance or data processing, and finally a set of targeted maintenance plans suitable for the user's lawn is generated. Moreover, at the regional level, more macro-regional turfgrass data can be obtained to provide regional turfgrass maintenance decision-making functions, so that turfgrass management can be regionalized, refined, intensive and intelligent.

Further, the lawn maintenance terminal device has a built-in initialization program module and sensor information intelligent calculation module, which is configured for user identification of the lawn maintenance terminal device, and may be connected with external devices to obtain an interactive interface for entering initial data information; equipped with sensors that identify the location, time and space environment, used to obtain information and perform intelligent edge calculations, used to coordinate the maintenance of lawn operations.

Further, the community terminal device has a built-in instruction module for receiving instructions from the management terminal device and guiding the user to manage multiple lawn maintenance terminal devices in the community.

Further, the database may include relational data storage area, used to store relational data manual input and received through sensors; evaluation data information storage area, used to store evaluation data information from evaluation equipment; algorithm program storage area, used to store related intelligent algorithm program modules; user data information storage area, used to store the lawn result information of each user; the statistical data storage area of regional lawns is used to store comprehensive statistical analysis data of multiple lawns in a certain area; the system operation data storage area is used to store the system operation data information.

Further, the system further includes a data visualization device. The data visualization device receives data from other devices, processes and displays data results based on a built-in algorithm program, and completes a data portrait of the regionalized lawn.

Further, the data visualization device has a built-in data program for receiving each device, a data statistical analysis program and a big data visualization program module, and has a function of providing data visualization display.

Further, the lawn maintenance terminal device, evaluation device, management terminal device, data visualization device, intelligent computing device, community terminal device, and database are configured as a tablet computer, computer, or application program interface for interacting with users.

Mobile smart device includes application program interface which is configured to interact with other functional components built in the corresponding device and external devices.

The second object of the present invention is to provide a regional lawn maintenance management method, so that lawn management can be regionalized, refined, intensive and intelligent.

The above second objective of the present invention is achieved by the following technical solutions.

A regionalized lawn maintenance management method includes the following steps: establishing a communication network connection between various devices. The community terminal equipment initializes the lawn maintenance terminal equipment and starts maintenance operations. User lawn maintenance related data may be collected based on lawn maintenance terminal equipment.

Based on the lawn maintenance-related data collected above, the maintenance plan information may be generated according to the algorithm program built in the intelligent computing device, and the maintenance plan information is input into the assessment device for assessment to generate corresponding assessment result information.

The management terminal device confirms the maintenance plan information corresponding to the above assessment result information, and selects whether to transmit the above maintenance plan information to the community terminal device and the lawn maintenance terminal device.

The lawn maintenance terminal equipment receives the management terminal equipment instruction, and after the specific confirmation operation of the community terminal equipment, according to the set maintenance plan, information is converted into a specific action that acts on lawn maintenance;

Based on the data collected during the lawn maintenance process of the user collected by the lawn maintenance terminal device, it is transmitted to the algorithm program built in the intelligent computing device and/or the assessment device to generate new assessment information.

By adopting the above technical solutions, the user can fully evaluate his own condition before performing regional lawn maintenance management, and then the intelligent computing device and the evaluation device generate suitable data for the above based on the evaluation data information and/or historical evaluation data information before, and after the lawn maintenance. The users maintenance plan information, and according to the feedback of the lawn maintenance terminal equipment, the above maintenance plan information is continuously optimized in subsequent maintenance or data processing, and finally a set of targeted maintenance plans suitable for the users lawn is generated. Moreover, at the regional level, more macro-regional turfgrass data can be obtained to provide regional turfgrass maintenance decision-making functions, so that turfgrass management can be regionalized, refined, intensive and intelligent.

Further, the following steps are included: the data visualization device receives the above evaluation result information, generates corresponding data display information according to its built-in setting algorithm, and perfects the portrait of the regionalized lawn.

Further, the steps of collecting user lawn maintenance-related data based on the lawn maintenance terminal equipment further include: the evaluation device receives the pre-, mid-, and post-maintenance data output by the lawn maintenance terminal device, and determines whether additional information is needed based on the algorithm program configured in itself and/or the intelligent computing device.

### Community Terminal Equipment;

The community terminal device receives the above inquiry information and performs corresponding operations according to the community terminal device holder.

Further, according to the algorithm program built in the intelligent computing device and/or the evaluation device, the step of generating new evaluation information further includes: based on the current evaluation data information, the relevant setting algorithm program module in the database and the historical evaluation data information related to the current evaluation data information are retrieved, and new evaluation information is generated and transmitted to the management terminal device.

The third objective of the present invention is to provide a commercial operation device, which can provide regional, refined, intensive and intelligent management based on lawn management, and provide commercial implementation data.

The above third objective of the present invention is achieved by the following technical solutions:

A commercial operation equipment, based on the purposed lawn maintenance management system, used to collect data from data visualization equipment, database, management terminal equipment, and calculates through the set own program module to conduct commercial activities of lawn maintenance in the area decision management.

The fourth object of the present invention is to provide a commercial operation device, which can provide regional, refined, intensive and intelligent management based on lawn management, and provide commercial implementation data.

The above fourth object of the present invention is achieved by the following technical solutions:

A commercial operation device, based on the lawn maintenance management method of objective 2, provides data to implement market behavior.

In summary, the present embodiment includes at least one of the following beneficial technical effects: collecting data information before, and after lawn maintenance through the lawn maintenance terminal device, and obtaining further inquiries based on the AI algorithm program of the evaluation device and/or intelligent computing device. The information, detection information or diagnostic information is continuously improved according to the input data of the lawn maintenance terminal equipment, and finally combined with the historical data information in the database, diagnostic information suitable for the user's lawn is generated and converted into maintenance plan information, which is sent after confirmation by the manager to the lawn maintenance terminal equipment, and then carry out the specific actions of lawn maintenance, the above process can achieve continuous optimization of data, and ultimately generate different maintenance data plan for different individuals, and at the same time analyze and evaluate the big data of the overall lawn in the region. The research and analysis of regional lawn green space and the innovation of lawn maintenance business model are of great significance.

### BRIEF DESCRIPTION

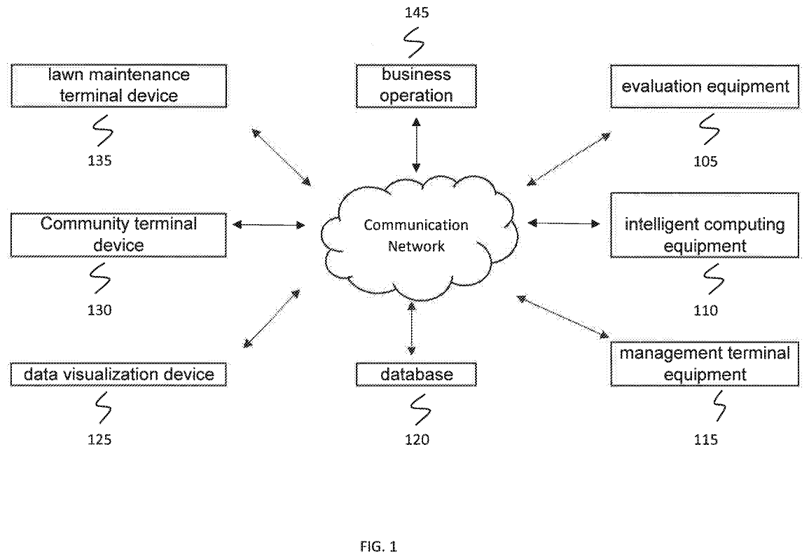

FIG. 1 is a block diagram of the original overall system of this application;

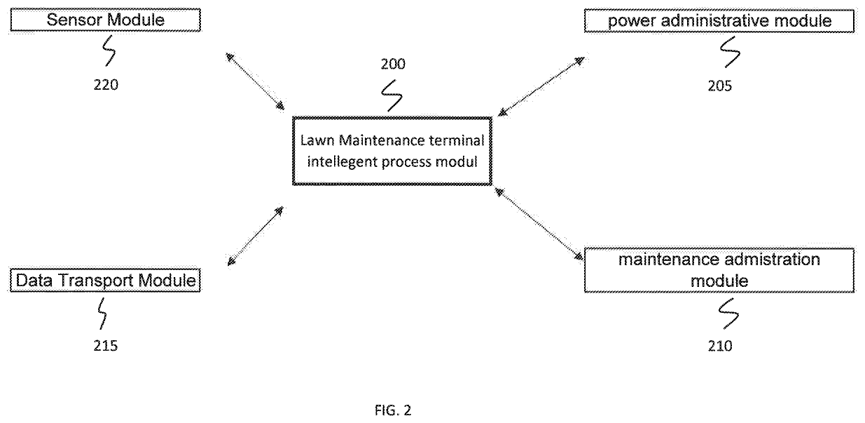

FIG. 2 is a system block diagram of the lawn maintenance terminal; and

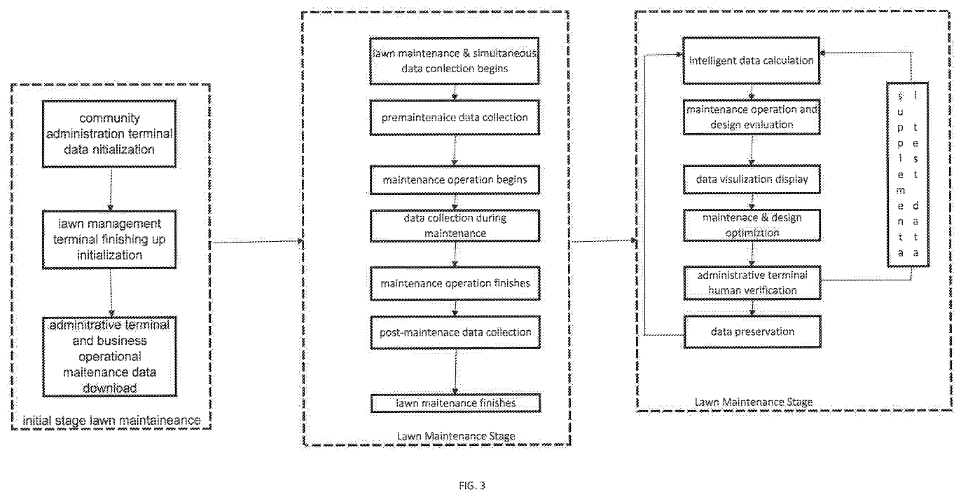

FIG. 3 is a program diagram of an application management method.

Reference: 105, evaluation equipment: 110, intelligent computing equipment; 125, data visualization equipment; 130, community terminal equipment; 115, management terminal equipment; 120, database; 145, business operation equipment; 135, lawn maintenance terminal equipment; 200, lawn maintenance terminal intelligent processing module; 220, sensor module; 215, data transmission module; 205, power management module 210, maintenance management module; 140, communication network.

### DETAILED DESCRIPTION

The present invention will be described in further detail below with reference to the drawings.

In order to facilitate the explanation of the solution of the present invention, the following description lists specific details to explain the solution of the invention. The embodiments of the present application described below can be applied or incorporated into different components, such as programs, circuits, devices, and systems. The structure and components shown in the block diagram are schematic illustrations of a specific embodiment of the present application. It should be understood that the connections between the components in the figure are not limited to direct connections, and the connections between components can be modified by intermediary redefine or change in other ways. In addition, those skilled in the art should recognize that the embodiments of the present invention described below can be implemented or embodied in various ways, such as method flows, devices, and systems.

The connections between components or systems in the figure are not limited to direct connections. The data between these components can be modified, reformatted, or otherwise changed by the intermediary components. In addition, additional or fewer connections can be used. It should also be noted that the term coupling should be understood to include direct connections, indirect connections through one or more intermediary devices, and wireless connections.

Reference to one embodiment, multiple embodiments, or a specific embodiment in this application refers to the specific features, structures, features, or functions described in at least one embodiment of the present invention and may be included in multiple implementation examples. In addition, the appearance of the above terms in different positions in the specification does not necessarily refer to the same embodiment.

This application will describe various embodiments of the regional lawn maintenance management system of this application with various structures and functional components, Those skilled in the art should understand that the above embodiments can be implemented in various environments, including but not limited to lawn management commercial units, lawn research units, and families. It should be noted that the regionalized lawn in this application may be a single lawn or multiple lawns, not limited to the number of lawns.

As shown in FIG. 1, it is a system framework diagram of an embodiment of the regional lawn maintenance management system, which includes a device 110, the community terminal device 130, the data visualization device 125, the management terminal device 115, the database 120, and the business operation device 145. The lawn maintenance terminal device 135, the evaluation device 105, an intelligent computing device 110, the community terminal device 130, the management terminal device 115, and the business operation device 145 can be a tablet computer, a computer, a smartphone, or other electronic devices in practice. Application program interface API for user interaction, which can interact with other components within the device, such as touch screens, keyboards, sensors, and even other external devices. The communication network 140 may be a local area network LAN, a wide area network WAN, a storage area network AAN, or a combination thereof. The communication network 140 may be configured to support various communication methods, including but not limited to WiFi communication, ethernet communication, Bluetooth communication, optical fiber communication, quantum communication, and the like.

Among them, the lawn maintenance terminal device 135 has a built-in initialization program module and a sensor information intelligent calculation module, which is configured for user identification of the lawn maintenance terminal device 135, and is connected with external equipment data to obtain an interactive interface for entering initial data information; equipped with sensors that identify the location, time and space environment, used to obtain information and perform intelligent edge calculations, used to coordinate and maintain lawn operations.

As shown in FIG. 2, the lawn maintenance terminal device 135 mainly includes an interconnected sensor module 220, a data transmission module 215, a power management module 205, a maintenance management module 210 and a lawn maintenance terminal intelligent processing module 200. Among them, the sensor module 220 collects data through various sensors; the lawn maintenance terminal intelligent processing module 200 performs intelligent calculation processing of the data; the data transmission module 215 receives from the management terminal device 115, the community terminal device 130 and the evaluation device through the communication network 140 and 105, and output the data processed by its own system; the power management module 205 is used for power supply and management; the maintenance management module 210 is used for maintenance operation management.

The above-mentioned sensor module 220, data transmission module 215, power management module 205, maintenance management module 210 and lawn maintenance terminal intelligent processing module 200 may in practice have an application program interface API for interacting with users. Other components within the device, such as touch screens, keyboards and sensors, and even other external devices interact.

In particular, the sensor module 220 contains a variety of physical, chemical, spatial, image, voice and other sensors, with various relevant parameters for automatically collecting lawns, including grass growth detection, soil quality detection, compound nitrogen, phosphorus and potassium detection, moisture detection, PH detection, temperature detection, geographical position detection, fallen leaf detection, obstacle detection, moving object detection, lawn edge detection, weed detection, forage parameter weight, volume, etc. detection, disease and pest detection, sunshine detection, altitude detection, self-checking. The sensor module 220 is connected to the intelligent processing module 200 of the lawn maintenance terminal to perform intelligent calculation and analysis.

The intelligent processing module 200 of the lawn maintenance terminal is configured with a module with related intelligent calculation programs, which can perform preliminary analysis and calculation on various types of data from the sensor module 220, the data transmission module 215, the power management module 205, and the maintenance management module 210. A control instruction is generated for the lawn maintenance terminal device 135 to automatically manage the lawn maintenance operation and sent to the maintenance management module 210 to implement the specific operation.

The data transmission module 215 is a communication management module for data input and output, and performs data exchange with other devices such as the smart computing device 110, the community terminal device 130, the management terminal device 115, and the database 120 through the communication network 140.

The power management module 205 manages the power supply of the lawn maintenance terminal device 135, including power supply dynamic monitoring, power supply residual alarm, charging socket identification, and sending power residual data to the lawn maintenance terminal intelligent processing module 200, from which the drive maintenance management module 210 issues. The move command closes the charging socket and charges, and returns to the working state after charging.

The maintenance management module 210 is a management module for the specific operation of the maintenance operation of the lawn maintenance terminal device 135. This module receives instructions from the intelligent processing module 200 of the lawn maintenance terminal, and specifically implements the lawn parameter detection, including the above-mentioned soil quality detection and moisture detection. Turf maintenance action control, including self-movement and memory, cutting height determination, lawn cutting action, obstacle avoidance, moving object avoidance, atomized watering, drug spraying, fertilizer implementation, forage judgment and intelligent dumping, lawn falling leaf identification, lawn falling leaf cleaning with dumping etc. Manage personal recognition, including face recognition, voice recognition, fingerprint recognition and other management initialization.

It should be noted that each of the above modules can be configured as a component containing various functions, and some modules can be integrated as a module, for example, the sensor module 220, the lawn processing terminal intelligent processing module 200, and the maintenance management module 210 and the data transmission module 215 are integrated in one module, and the corresponding software is installed to achieve the required functions; all the operation data of the lawn maintenance terminal device 135 is saved through the communication network 140 to the database 120. When the data analysis or the next diagnosis is performed later, the above new diagnosis information can be used as a reference, so that the system data can be continuously optimized.

Based on the above-mentioned lawn maintenance terminal device 135 system module, the lawn maintenance terminal device 135 may be used to receive the operation instruction of the management terminal device 115 and execute it with the assistance of the community terminal device 130 or directly execute the operation instruction. The data of lawn maintenance work and user lawn maintenance is collected and sent to the intelligent computing device 110. In addition to completing maintenance operations, the lawn maintenance terminal device 135 also has a self-measurement device that automatically collects data information on the lawn and surrounding environment, such as a lawn morphology tester, grass analyzer, soil quality analyzer, PH tester, etc. The community terminal device 130 is authorized by the management terminal device 115 to perform detection assistance.

In particular, the lawn maintenance terminal device 135 has a built-in initialization program module configured for data connection with the community terminal device 130 to obtain an interactive interface for inputting initial data information, such as user personal name information and lawn-related information. In some embodiments, the lawn maintenance terminal device 135 may transmit data to other devices in an encrypted format through the above-mentioned communication network 140.

The community terminal device 130 can be configured as a smartphone with related applications installed. The above applications can be downloaded through the download link provided by the lawn service provider. Once the user registers or logs in, the downloadable link will be sent to the user's smartphone. After that, the holder of the community terminal device 130 can download, install, and execute instructions from the mobile phone app.

In addition, the algorithm program applied to the evaluation device 105 may be stored in the evaluation device 105 itself, or may be stored in the smart computing device 110. Generally, for some simple data information output by the lawn maintenance terminal device 135, the algorithm program built in the evaluation device 105 can be used to evaluate and output the corresponding query information. For some complex maintenance data information, the above data information needs to be transmitted to the intelligent computing device 110 for complex calculation. In a specific embodiment, the above intelligent computing device 110 may be configured in the cloud, and the evaluation device 105 performs data communication with the intelligent computing device 110 through the network 140.

The intelligent computing device 110 is configured with a set program algorithm, usually including an AI program algorithm, receives data information from the lawn maintenance terminal device 135, and generates query information or lawn diagnostic information based on the built-in set algorithm program, the query information is output to the community terminal device 130 and the lawn maintenance terminal device 135, and the diagnostic information is input to the evaluation device 105 or confirmed by the management terminal device 115 and then output to the community terminal device 130 and the lawn maintenance terminal device 135. The lawn diagnosis and implementation information is generated using the AI program of the intelligent computing device 110, which has an evolutionary algorithm built in. The AI program for generating diagnostic information and the AI program for generating embodiment information can share the same hardware, but use different software modules. The intelligent computing device 110 may be a centralized server or a cloud-based server.

In some embodiments, at least one evaluation device 105 corresponds to the lawn maintenance terminal device 135 and/or the management terminal device 115. The community terminal device 130 may perform lawn detection through the assisted lawn maintenance terminal device 135 after authorization, or be instructed by the evaluation device 105 to perform automatic detection.

Further, if the management terminal needs to supplement the collected data during the manual confirmation of the management terminal, the management terminal device 115 may issue a supplementary detection instruction to drive the lawn maintenance terminal device 135 to perform the detection operation.

In order to facilitate the familiarity and operation of the community terminal device 130 holders, the lawn maintenance terminal device 135 and the community terminal device 130 have built-in guidance program modules for guiding users to use, and related application programs may also be loaded in the community terminal device 130 to guide the use of lawn maintenance terminal equipment 135. In some embodiments, the community terminal device 130 may be configured as various application program modules, including a program module with an augmented reality function, to ensure that the user uses the lawn maintenance terminal device 135 correctly.

In detail, the lawn maintenance terminal device 135 receives the implementation operation plan confirmed by the management device 115 through the communication network 140, and performs specific operation actions, including lawn identification, intelligent mowing, grass identification, soil quality test, PH test, and moisture test, temperature test, animal avoidance, obstacle photography, distress alarm, automatic charging, language recognition, universal recognition, altitude recognition, geographic recognition, forage dumping, data upload, atomized irrigation, drug spraying, fertilizer implementation, lawn leaf recognition, sweeping and dumping of lawn leaves.

The intelligent computing device 110 provides maintenance plan information to the evaluation device 105 for customizing a personalized maintenance plan suitable for a lawn. For example, the trim height of a lawn, the inspection of missing parts, the number of fogging, diagnosis of diseases and insect pests, etc. The above-mentioned specific operation plan is provided to the management terminal device 115 through the evaluation device 105 for confirmation, and after confirmation, it is transmitted to the lawn maintenance terminal device 135 to start the operation, and the database 120 stores these data.

The community terminal device 130 securely transmits information in an encrypted form to ensure the privacy and authenticity of the data input by the user, and the transmission method of the data of other devices in the system is also handled in the same way. The above-mentioned encrypted communication can be implemented by applying security functions embedded in the hardware and/or software of the device, and these hardware and/or software can enable the security functions when transmitting and storing sensitive data.

In some embodiments, the community terminal device 130 and the lawn maintenance terminal device 135 have sensors for collecting user identity and lawn-related information, which can be used for user identification and/or identity verification. The above-mentioned sensor may be a fingerprint sensor, an iris scanner, a grass-type recognizer, a chemical sensor, an image camera, or the like. In some embodiments, the sensor uses pre-loaded software to perform identification, authentication, and data collection for images, physical, and chemical environments.

The community terminal device 130 may be a smart phone, a tablet computer, or a laptop computer installed with an automatic service program. The automatic service program may be downloaded through a download link provided by a service provider, and the link is provided when the holder user registers. After the installation is completed, an application program interface API is displayed on the screen of the community terminal device 130 to guide the community administrator to start the automatic service. The above-mentioned automatic services include but are not limited to: automatically acquiring user parameters for detection and sending them to the evaluation device 105.

In this application, the management terminal device 115 receives the lawn maintenance plan information output by the evaluation device 105, determines and confirms the feasibility of the plan contained in the above maintenance plan information according to the operation of the manager, and outputs the maintenance plan information to the community terminal device 130 if feasible grants authorization to initialize the lawn maintenance terminal device 135 and confirm the operation start, and the lawn maintenance terminal device 135 starts specific operation actions.

The database 120 receives and stores various data information and various setting algorithm data output by each device to form historical data, multiple intelligent calculation data and a knowledge base. In detail, the database 120 mainly includes: a relational data storage area for the community terminal device 130 to store manually input relational data. The relational data includes the user ID and its evaluation data information, lawn diagnostic information, maintenance plan information, etc. Correspondence data of information; evaluation data information storage area for storing evaluation data information from the lawn maintenance terminal device 135 and/or evaluation device 105; algorithm program storage area for storing related intelligent algorithm program modules; for storing each of the maintenance data information storage area for the user's maintenance data information; the system operation data storage area for storing the system's operation data information; and the data storage area for the commercial operation of lawn maintenance.

In the above embodiments, there are mainly four data sources in the database 120. The first source is data manually input, the second source is raw data of the lawn maintenance terminal 135, the third source is evaluation data, system usage data, and machine learning data, and the fourth source is commercial data. The above-mentioned devices are coupled through one or more communication networks 140 with wired or wireless connections to exchange information.

The data visualization device 125 has built-in data programs, data statistical analysis programs and big data visualization program modules for receiving various devices, and has the function of providing data visualization display. The data visualization device 125 receives data from other devices, processes and displays the data results based on the built-in algorithm program, completes the data portrait of the regionalized lawn, and provides it to the management device 115 as a management decision aid.

The commercial operation equipment is based on the data generated by the lawn maintenance management, and the operation management of the lawn maintenance through the commercial operation management program, including lawn customer management, terminal lease management, operation plan management, etc.

Refer to FIG. 3 for the above regional lawn maintenance management method.

It should be noted that each of the above-mentioned devices can be configured as a component containing various functions, and some devices can be integrated as one device, for example, integrating lawn maintenance terminal device 135, intelligent computing device 110, and evaluation device 105 in an intelligent mobile terminal, application software or APP can be installed on these devices to achieve desired functions.

The embodiments of this specific embodiment are all embodiments of the present invention and do not limit the scope of protection of the present invention accordingly, Therefore, any equivalent changes made according to the structure, shape and principle of the present invention should be covered in within the protection scope of the present invention.

1. A regionalized lawn maintenance management system, comprising: lawn maintenance terminal equipment, evaluation equipment, intelligent computing equipment, and community terminal equipment connected via a communication network, management terminal equipment, database,
wherein the lawn maintenance terminal equipment is used to collect user lawn maintenance-related data and automatically and intelligently trim and maintain the lawn; the user lawn maintenance-related data is transmitted and exchanged to various devices through the communication network, and the maintenance is performed according to the set algorithm; the plan information is converted into specific lawn maintenance operations;
the community terminal equipment is used by the community administrator to collect and input user change data before and after user initialization and maintenance, and exchange data with other equipment;
evaluation equipment, through the communication network and other equipment for data exchange, based on the knowledge base of the database and the lawn maintenance terminal equipment data input intelligent computing equipment calculation, after which, an evaluation is made based on its own algorithm program, and the evaluation data is transmitted to the management device, which is judged and confirmed by the management personnel, and the related data is transmitted to the lawn maintenance terminal and the database through the communication network;
the intelligent computing device receives information from the lawn maintenance end device and other equipment, generates maintenance plan information based on the built-in setting algorithm program, and outputs it to the management end device after confirming with lawn maintenance terminal equipment and other equipment;
the management device receives the lawn attributes and maintenance plan information output by the evaluation device and the database, judges and confirms the feasibility of the included maintenance plan according to the operation of the manager, and outputs the maintenance plan if feasible Information to the lawn maintenance terminal equipment; and
the database receives and stores various data information and various setting algorithm data output by each device to form historical data, multiple intelligent calculation data and knowledge base,

2. The regionalized lawn maintenance management system according to claim 1, wherein the lawn maintenance terminal device is built with an initialization program module and a sensor information intelligent calculation module, and is configured for a lawn maintenance terminal device with user identification, and data connection with external devices to obtain the interactive interface for entering the initial data information; equipped with sensors that identify the location, time, and spatial environment, used to obtain information and perform edge intelligent calculations, and to coordinate the maintenance of lawn operations.

3. The regionalized lawn maintenance management system according to claim 1, wherein the community terminal device has a built-in instruction program module for receiving instructions from the management device and guiding users, used to manage multiple lawn maintenance terminal equipment in the community.

4. The regionalized lawn maintenance management system according to claim 1, wherein the database comprises:
relational data storage area used to store relational data manually input and received through sensors;
evaluation data information storage area used to store evaluation data information from the evaluation device;
algorithm program storage area used to store related intelligent algorithm program modules;
user data information storage area used to store the lawn result information of each user;
the statistical data storage area of regional lawns is used to store comprehensive statistical analysis data of multiple lawns in a certain area;
wherein the system operation data storage area is used to store the system operation data information.

5. The regionalized lawn maintenance management system according to claim 1, further comprises a data visualization device, and the data visualization device receives other various devices, wherein the data is processed and displayed based on the built-in algorithm program to complete the data portrait of the regionalized lawn.

6. The regionalized lawn maintenance management system according to claim 5, wherein the data visualization device has a built-in data program and data statistical analysis program for receiving each device with the big data visualization program module, which has the function of providing data visualization display.

7. The regionalized lawn maintenance management system according to claim 5, wherein the lawn maintenance terminal equipment, evaluation equipment, management terminal equipment, and data visualization equipment, smart computing device, community terminal device, database are configured as tablets, computers, mobile smart devices with application program interfaces for interacting with users; wherein the application program interface is configured to interact with other functional components built in the corresponding device and external devices.

8. A regionalized lawn maintenance management method, comprising:
establishing a communication network connection between various devices;
initializing the lawn maintenance terminal equipment and starting maintenance operations by community terminal equipment;
collecting user lawn maintenance related data based on lawn maintenance terminal equipment;
based on the lawn maintenance-related data collected above, generating a maintenance plan information according to the algorithm program built in the intelligent computing device, and the maintenance plan information being input into the assessment device for assessment to generate corresponding assessment result information;
confirming the maintenance plan information corresponding to the above evaluation result information, and selecting whether to transmit the above maintenance plan information to the community terminal device and the lawn maintenance terminal device by the management terminal device;
receiving instructions from the management terminal device, and after the specific confirmation operation of the community terminal device via the lawn maintenance terminal device, converting it into specific actions that act on lawn maintenance according to the set maintenance plan information;
based on the data collected by the user of the lawn maintenance terminal device during the lawn maintenance process of the user, transmitting the algorithm program built in the intelligent computing device and/or the evaluation device to generate new evaluation information.

9. The regionalized lawn maintenance management method according to claim 8, further comprising the step of: the data visualization device receiving the evaluation result information, and generating a corresponding one according to its built-in setting algorithm data display information, perfecting the portrait of regionalized lawn.

10. The regionalized lawn maintenance management method according to claim 8, wherein the step of collecting user lawn maintenance-related data based on the lawn maintenance terminal device further comprises:
the evaluation device receives the pre-, mid-, and post-maintenance data output by the lawn maintenance terminal device, and judges whether further supplementary information is needed based on the algorithm program configured in itself and/or the intelligent computing device, generating the corresponding inquiry information and sending it to the community terminal device;
the community terminal device receiving the above inquiry information and performing corresponding operations according to the community terminal device holder.

11. The regionalized lawn maintenance management method according to claim 8, characterized in that the step of generating new evaluation information according to an algorithm program built in the intelligent computing device and/or the evaluation device further comprises:
based on the current evaluation data information, the relevant setting algorithm program module in the database and the historical evaluation data information related to the current evaluation data information are retrieved, and new evaluation information is generated and transmitted to the management device.

12. A commercial operation device, characterized in that it is based on the regionalized lawn maintenance management system according to claim 5, which is used for data collection visual device, database, management terminal device data, and through the calculation of its own program module, make decision management on the commercial behavior of lawn maintenance in the area.

13. A commercial operation device, characterized in that, based on the regionalized lawn maintenance management method according to claims 9, providing data to implement market behavior.
